(19) United States
(12) Patent Application Publication
(10) Pub. No.: US 2025/0230825 A1
(43) Pub. Date: Jul. 17, 2025

(54) ACCESS CONTROL DEVICES, INSTALLATION MECHANISMS THEREOF, AND METHODS OF ASSEMBLING AND DISASSEMBLING THE SAME

(71) Applicant: Consumer 2.0 Inc., LOS ANGELES, CA (US)

(72) Inventors: Zhong LIANG, Shenzhen (CN); Clark Zhe LI, Los Angeles, CA (US)

(21) Appl. No.: 18/409,836

(22) Filed: Jan. 11, 2024

(51) Int. Cl. F16B 5/02; F16B 5/00

(52) U.S. Cl. CPC F16B 5/0208; F16B 5/0084

(57) ABSTRACT

One example embodiment is an access control device comprising an improved installation mechanism, that at least includes a bolt assembly and a geared motor assembly with an eccentric shaft. The geared motor assembly comprising the eccentric shaft is configured to operatively rotate eccentrically, actuating the vertical displacement of the bolt assembly. When the bolt assembly is biased in an extended position, a first snap-fit lock snap-fits with the bolt assembly, forming a locked state, and when the bolt head portion is biased in a retracted position, the first snap-fit lock is released from the bolt assembly, forming an unlocked state, thereby enabling assembly to and disassembly of the device. Other example embodiments are described herein. In certain embodiments, the present invention provides the improved access control solutions that are more secure and easier to set up.

### FIELD OF INVENTION

This application relates to the field of locking devices. In particular, this application relates to access control devices, installation mechanisms thereof, and methods of assembling and disassembling the same.

### BACKGROUND OF INVENTION

At present, existing access control devices mostly are installed by fastening screws in the front or mounting screws at the bottom, etc. These kinds of installation structures have many shortcomings. For example, they often have less attractive appearances and aesthetics due to the disruption of unity. Moreover, existing devices suffer from reduced safety and practical performance as they can be easily dismantled by intruders employing common tools such as a screwdriver. Therefore, there is an urgent need for improved access control devices that offer easy operation, have an exquisite structure, and provide a high-security factor.

### SUMMARY OF INVENTION

In light of the foregoing background, in certain embodiments, provided is an improved installation mechanism, a novel access control device having such improved installation mechanism, and methods of installing the access control device.

Accordingly, in one aspect, provided is an access control device comprising a front panel, comprising a bolt assembly and a geared motor assembly; wherein the bolt assembly comprises a bolt body and a bolt spring; wherein the bolt body comprises a bolt head portion and a bolt slot; and a rear panel, comprising a first snap-fit lock; wherein the first snap-fit lock is sized and shaped to snap-fit with the bolt head portion, and wherein the geared motor assembly comprises an eccentric shaft, the geared motor assembly is configured to operatively rotate eccentrically, such that the eccentric shaft is switchable between an upper shaft position and a lower shaft position; and wherein the bolt assembly and the geared motor assembly are constructed and arranged such that the eccentric shaft abuts against the bolt slot, such that when the eccentric shaft is in the upper shaft position, the bolt head portion is biased in an extended position, the first snap-fit lock is able to snap fit with the bolt head portion, forming a locked state; and when the eccentric shaft is in the lower shaft position, the bolt head portion is biased in a retracted position, the first snap-fit lock is released from the bolt head portion, forming an unlocked state, thereby enabling the front panel to be assembled to and disassembled from the rear panel.

In another aspect, the provided an installation mechanism for assembling and disassembling an access control device that comprises a front panel and a rear panel, the installation mechanism comprising: a bolt assembly and a geared motor assembly that are provided on the front panel assembly; wherein the bolt assembly comprises a bolt body and a bolt spring; wherein the bolt body comprises a bolt head portion and a bolt slot; and a first snap-fit lock that is provided on the rear panel, wherein the first snap-fit lock is sized and shaped to snap fit with the bolt head portion, wherein the geared motor assembly comprises an eccentric shaft, the geared motor is configured to rotate eccentrically, such that the eccentric shaft is switchable between an upper shaft position and a lower shaft position, and wherein the bolt assembly and the geared motor assembly are constructed and arranged such that the eccentric shaft abuts against the bolt slot, such that when the eccentric shaft is in the upper shaft position, the bolt head portion is biased in an extended position, the first snap-fit lock can snap-fit with the bolt head portion, forming a locked state; and when the eccentric shaft is in the lower shaft position, the bolt head portion is biased in a retracted position, the first snap-fit lock is released from the bolt head portion, forming an unlocked state, thereby enabling the front panel to be assembled to and disassembled from the rear panel. Other example embodiments will be described below.

There are many advantages of the present disclosure. In certain embodiments, the provided access control devices and installation mechanisms offer easy assembling and disassembling without the need for additional tools such as screws or mounting tools, hence simplifies the setup process and saves time. In certain embodiments, the access control devices have enhanced visual appeal, contributing to an overall aesthetic and unified appearance. In certain embodiments, the provided access control devices and installation mechanisms are more resistant to tampering or unauthorized access, offering a higher level of security compared to the existing access control devices in the market.

### BRIEF DESCRIPTION OF FIGURES

FIG. 1 is an exploded diagram of components of an example access control device comprising the example installation mechanism, according to an example embodiment.

FIG. 2 is a partial diagram of the rear side of the front panel comprising the middle frame, antenna cover, back cover and bolt assembly of an example access control device, according to the example embodiment.

FIGS. 3A-3C are various views of the bolt assembly of an example access control device, according to the example embodiment. FIG. 3A is a perspective view of the bolt assembly, showing bolt body, bolt slot and bolt spring. FIG. 3B is a top view of the bolt assembly, showing the bolt head portion. FIG. 3C is a cross-sectional view A-A of the bolt assembly according to FIG. 3B, showing the guided slant side of the bolt body and the accommodating cavity receiving a portion of the bolt spring.

FIGS. 4A-4C are various views of the geared motor assembly, according to the example embodiment. FIG. 4A illustrates the opposing perspective views of the geared motor assembly, comprising the eccentric shaft, according to the example embodiment. FIG. 4B is a front view of the geared motor assembly. FIG. 4C shows the rotatory action of the eccentric shaft from the upper shaft position to the lower shaft position, according to the example embodiment.

FIGS. 5A-5B are a perspective view of the bottom of a front panel of an example installation mechanism in the example access control device, and an enlarged view thereof respectively, according to the example embodiment.

FIGS. 6A-8B and 7A-7B are cross-sectional views of an example access control device comprising the example installation mechanism, and the enlarged views thereof, illustrating the assembly process of the front panel onto the rear panel, where the snap-fit groove of the front panel is inserted into the second snap-fit lock of the rear panel (FIG. 6A-6B), and when the top of the front panel is press-snapped onto the rear panel, the first snap-fit lock presses against the guided slant side of the bolt head portion, causing the bolt spring and thus the bolt assembly to retract and the first snap-fit lock passes over the bolt head portion, the bolt head portion extends from the retracted position and first snap-fit lock closes around the bolt head portion (FIG. 7A-7B).

FIGS. 8A-8B, 9A-9B and 10A-10B are cross-sectional views of an example access control device comprising the example installation mechanism, and the enlarged views thereof, illustrating the disassembly process of the front panel from the rear panel, where the eccentric shaft is in the lower shaft position, compressing the bolt spring to drive the bolt assembly into the retracted position (FIGA. 8A-8B), enabling the first snap-fit lock to be separated from the bolt head portion and forming the unlocked state (FIG. 9A-9B), and subsequently, the eccentric shaft rotates back to the upper shaft position, returning the bolt assembly to the extended position (FIG. 10A-10B), according to the example embodiment.

FIG. 11 is a flow chart diagram of an example method of assembling and disassembling an access control device, according to the example embodiment.

### DETAILED DESCRIPTION

### Definitions

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising”, “including,” or “containing,” embodiments.

For the sake of clarity, “comprising”, “including”, “containing” and “having”, and any related forms are open-ended terms which allows for additional elements or features beyond the named essential elements, whereas “consisting of” is a closed end term that is limited to the elements recited in the claim and excludes any element, step, or ingredient not specified in the claim.

As used herein, the singular forms “a”, “an” and “the” are intended to include the plural forms as well, unless the context clearly indicates otherwise. Where a range is referred in the specification, the range is understood to include each discrete point within the range. For example, 1-7 means 1, 2, 3, 4, 5, 6, and 7.

As used herein, the term “about” is understood as within a range of normal tolerance in the art and not more than ±10% of a stated value. By way of example only, about 50 means from 45 to 55 including all values in between. As used herein, the phrase “about” a specific value also includes the specific value, for example, about 50 includes 50.

As used herein and in the claims, the terms “general” or “generally”, or “substantial” or “substantially” mean that the recited characteristic, angle, shape, state, structure, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, an object that has a “generally” cylindrical shape would mean that the object has either an exact cylindrical shape or a nearly exact cylindrical shape. In another example, an object that is “substantially” perpendicular to a surface would mean that the object is either exactly perpendicular to the surface or nearly exactly perpendicular to the surface, e.g., has a 5% deviation.

It is to be understood that terms such as “top”, “bottom”, “front”, “rear”, “back”, “middle”, “side”, “length”, “inner”, “outer”, “interior”, “exterior”, “outside”, “vertical”, “horizontal” and the like as may be used herein, merely describe points of reference and do not limit the present invention to any particular orientation or configuration. Further, terms such as “first,” “second,” “third,” etc., merely identify one of a number of portions, components and/or points of reference as disclosed herein, and likewise do not limit the present invention to any particular configuration or orientation.

As used herein, the term “access control device” refers to a device or system designed to control access from a target region or area. In some embodiments, the access control device is or contains an electronic lock.

As used herein, the term “installation mechanism” refers to a component of a device or apparatus that facilitates the disassembly and reassembly of at least a portion of the device or apparatus from a target substrate such as a door or a wall.

As used herein, the term “bolt” refers to a mechanical component used for securing or releasing a locking mechanism within a device. By way of example, bolt is a locking tongue that interacts with a snap-fit lock.

As used herein, the term “geared motor” or “geared motor assembly” refers to an electric motor designed to provide rotational motion to drive another mechanical components such as bolts. In some embodiments, the rotational motion is eccentric rotation back and forth within a certain predetermined range (such as about 180°).

As used herein, “eccentric” or “eccentrically” refers to being off-center or deviating from the central axis or symmetry of a system or mechanism.

As used herein, a “shaft” refers to a rod-like or elongated component that operably connects with a geared motor.

As used herein, the term “snap fit” refers to a type of mechanical fastening that involves interlocking features or configurations on the corresponding mating surfaces of the components that create a connection when pressed or snapped together.

As used herein, the term “retract”, “retracted” or “retracting” refers to state, or entering a state where a component moves from a protruded position to a compressed position.

As used herein, the term “extend”, “extended” or “extending” refers to a state, or entering a state where a component is moved from a compressed position to a protruded position.

As used herein, the term “front panel” refers to a component, part, element or surface disposed at the front side of a device, facing the users.

As used herein, the term “back cover” refers to a component, part or element that at least partially covers the rear side of a device or a portion of the device, disposed at the side away from the users.

As used herein, the term “assemble”, “assembling” or “assembly” refers to the process or act of combining or connecting individual components, parts or elements to form a complete unit.

As used herein, the term “disassemble”, “disassembling” or “disassembly” refers to the process or act of taking apart the assembled components, parts or elements of a device.

Although the description referred to particular embodiments, the disclosure should not be construed as limited to the embodiments set forth herein.

### Numbered Embodiments

Embodiment 1. An access control device, comprising: a front panel, comprising a bolt assembly and a geared motor assembly; wherein the bolt assembly comprises a bolt body and a bolt spring; wherein the bolt body comprises a bolt head portion and a bolt slot; and a rear panel, comprising a first snap-fit lock; wherein the first snap-fit lock is sized and shaped to snap-fit with the bolt head portion, and wherein the geared motor assembly comprises an eccentric shaft, the geared motor assembly is configured to operatively rotate eccentrically, such that the eccentric shaft is switchable between an upper shaft position and a lower shaft position; and wherein the bolt assembly and the geared motor assembly are constructed and arranged such that the eccentric shaft abuts against the bolt slot, such that when the eccentric shaft is in the upper shaft position, the bolt head portion is biased in an extended position, the first snap-fit lock is able to snap fit with the bolt head portion, forming a locked state; and when the eccentric shaft is in the lower shaft position, the bolt head portion is biased in a retracted position, the first snap-fit lock is released from the bolt head portion, forming an unlocked state, thereby enabling the front panel to be assembled to and disassembled from the rear panel.

Embodiment 2. The access control device of embodiment 1, wherein the front panel further comprises a front panel middle frame and a main control assembly that is operably connected with the geared motor assembly, the bolt assembly, wherein the geared motor assembly, and the main control assembly are installed into the front panel middle frame.

Embodiment 3. The access control device of embodiment 1-2, wherein the front panel middle frame is provided with a snap-fit groove, and the rear panel is provided with a second snap-fit lock that is sized and shaped to match with the snap-fit groove of the front panel middle frame.

Embodiment 4. The access control device of embodiment 3, wherein the front panel assembly further comprises a touch screen, a touch PCBA board that is operably connected with the touch screen and the main control assembly, such that in response to an input signal from the touch screen, the eccentric shaft is switchable between the upper shaft position and the lower shaft position by controlling the geared motor assembly via the main control assembly, causing the bolt assembly is biased between the extended position and the retracted position.

Embodiment 5. The access control device of embodiment 1-4, wherein the bolt body comprises an accommodating cavity to receive at least a portion of the bolt spring, the opposing portion of the bolt spring abuts against an inner wall of the front panel middle frame.

Embodiment 6. The access control device of embodiment 1-5, wherein the front panel further comprises a front panel back cover, comprising a back cover front face and a back cover rear face, the back cover front face is sized and shaped to fixedly connect with the front panel middle frame, and the back cover rear face is sized and shaped to match with the rear panel.

Embodiment 7. The access control device of embodiment 1-6, wherein a top portion of the front panel further comprises an antenna cover.

Embodiment 8. The access control device of embodiment 1-7, wherein the rear panel comprises a rear panel front face and an opposing, rear panel back face, the rear panel back face is configured to be fixable onto a target substrate, and the rear panel front face comprises the first snap-fit lock.

Embodiment 9. The access control device of embodiment 1-8, wherein the bolt head portion further comprises a guiding slant side.

Embodiment 10. An installation mechanism for assembling and disassembling an access control device that comprises a front panel and a rear panel, the installation mechanism comprising: a bolt assembly and a geared motor assembly that are provided on the front panel assembly; wherein the bolt assembly comprises a bolt body and a bolt spring; wherein the bolt body comprises a bolt head portion and a bolt slot; and a first snap-fit lock that is provided on the rear panel, wherein the first snap-fit lock is sized and shaped to snap fit with the bolt head portion, wherein the geared motor assembly comprises an eccentric shaft, the geared motor is configured to rotate eccentrically, such that the eccentric shaft is switchable between an upper shaft position and a lower shaft position, and wherein the bolt assembly and the geared motor assembly are constructed and arranged such that the eccentric shaft abuts against the bolt slot, such that when the eccentric shaft is in the upper shaft position, the bolt head portion is biased in an extended position, the first snap-fit lock can snap-fit with the bolt head portion, forming a locked state; and when the eccentric shaft is in the lower shaft position, the bolt head portion is biased in a retracted position, the first snap-fit lock is released from the bolt head portion, forming an unlocked state, thereby enabling the front panel to be assembled to and disassembled from the rear panel.

Embodiment 11. The mechanism of embodiment 10, wherein the front panel further comprises a front panel middle frame and a main control assembly, the geared motor assembly is operably connected with the main control assembly, wherein the bolt assembly, the geared motor assembly and the main control assembly are installed into the front panel middle frame.

Embodiment 12. The mechanism of embodiment 11, further comprising a snap-fit groove that is provided on the front panel middle frame, and a second snap-fit lock that is provided on corresponding bottom portion of the rear panel and that is sized and shaped to match with the snap-fit groove.

Embodiment 13. The mechanism of embodiment 10-12, wherein the front panel assembly further comprises a touch screen, a touch PCBA board that is operably connected with the touch screen and the main control assembly, such that in response to an input signal from the touch screen, the eccentric shaft is switchable between the upper shaft position and the lower shaft position by controlling the geared motor assembly via the main control assembly, causing the bolt assembly is biased between the extended position and the retracted position.

Embodiment 14. The mechanism of embodiment 10-13, wherein the bolt body comprises an accommodating cavity to receive at least a portion of the bolt spring, the opposing portion of the bolt spring abuts against an inner wall of the front panel middle frame.

Embodiment 15. The mechanism of embodiment 10-14, wherein the rear panel comprises a rear panel front face and an opposing, rear panel back face, the rear panel back face is configured to be fixable onto a target substrate, and the first snap-fit lock is disposed on the rear panel front face.

Embodiment 16. The mechanism of embodiment 10-15, wherein the bolt head portion further comprises a guiding slant side.

Embodiment 17. A method of assembling and disassembling an access control device, comprising the steps of: providing the access control device of any one of embodiments 1-9, the access control device comprises a front panel assembly and a rear panel, the eccentric shaft being in the upper shaft position; fixating a rear panel onto a target substrate; wherein installing of the front panel assembly comprises the steps of: press-snapping the front panel assembly onto the rear panel, such that the first snap-fit lock snap-fits with the bolt head portion, forming a locked state; and wherein disassembling of the front panel assembly comprises the steps of: operating the eccentric shaft of the geared motor assembly to the lower shaft position, causing the bolt head portion to be biased in the retracted position, the first snap-fit lock is released from the bolt head, forming an unlocked state, thereby the front panel assembly being disassembled from the rear panel.

Embodiment 18. The method of embodiment 17, wherein the front panel assembly further comprises a touch screen and a touch PCBA board, the touch PCBA board is operably connected with the touch screen and the main control assembly, wherein the operating the eccentric shaft of the geared motor assembly is performed by controlling the geared motor assembly via the main control assembly in response to an input signal from the touch screen, the eccentric shaft is switchable between the upper shaft position and the lower shaft position, causing the bolt assembly is biased between the extended position and the retracted position.

Embodiment 19. The method of embodiment 17-18, prior to the press-snapping the front panel assembly onto the rear panel, further comprising the step of: inserting the snap-fit groove of the front panel assembly into the second snap-fit lock that is provided on corresponding bottom portion of the rear panel and that is sized and shaped to match with the snap-fit groove.

Embodiment 20. The method of embodiment 17-19, after disassembling the front panel assembly, further comprising the step of: rotating the geared motor within a predetermined period of time to switch the eccentric shaft back to the upper shaft position, such that the bolt head portion is biased in the extended position, and the first snap-fit lock can snap fit with the bolt head portion when installing the front panel, returning to the initial, locked state.

### EXAMPLES

Provided herein are examples that describe in more detail certain embodiments of the present disclosure. The examples provided herein are merely for illustrative purposes and are not meant to limit the scope of the invention in any way. All references given below and elsewhere in the present application are hereby included by reference.

### Example 1: Example Installation Mechanism and Access Control Deivce

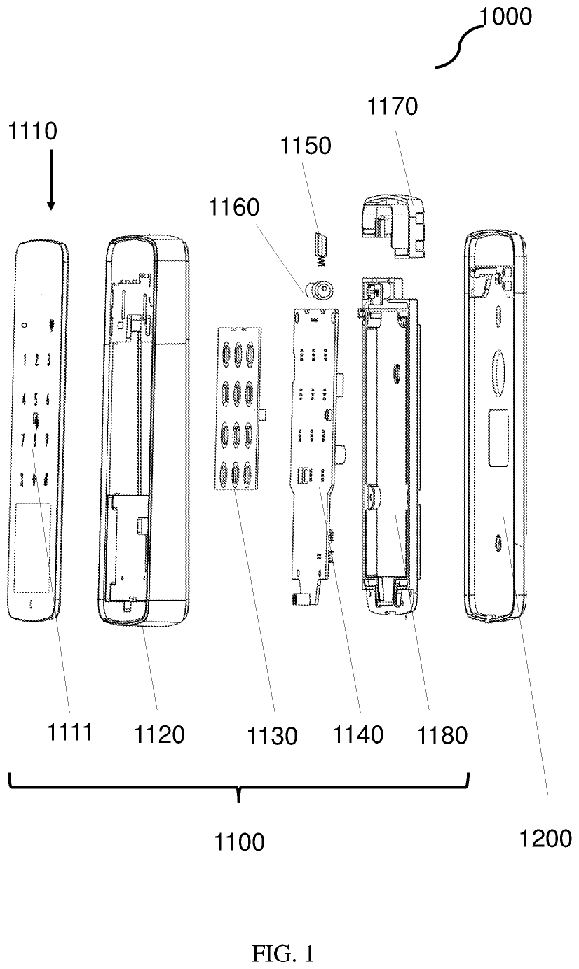

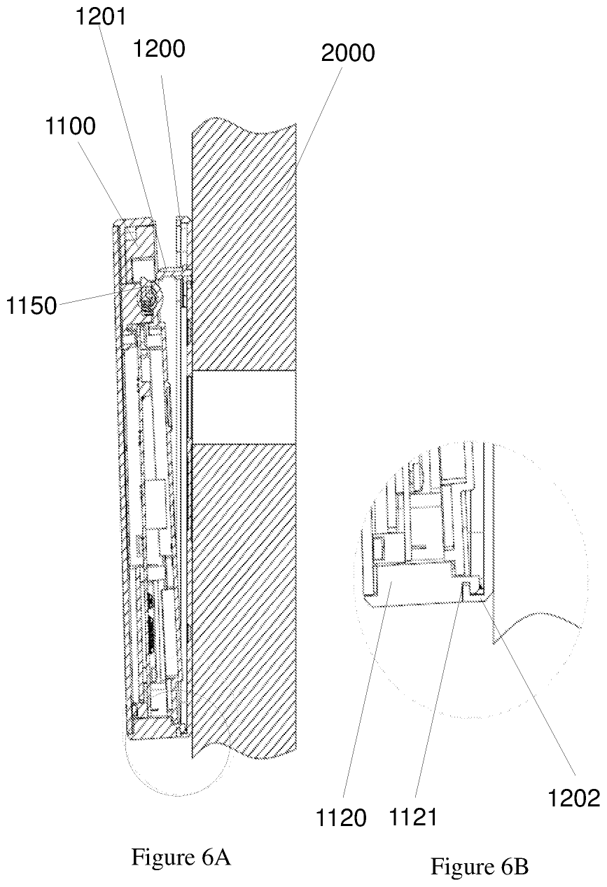

Now referring to FIGS. 1-6, showing example access control device 1000 having an example installation mechanism. FIG. 1 is an exploded view of the components of the example access control device 1000. The access control device 1000 generally contains a front panel assembly 1100 and a rear cover 1200. The front panel assembly 1100, from front side to the back side, includes a touch screen 1110, a middle frame 1120, a touch Printed Circuit Board Assembly (PCBA) board 1130, a main control PCBA board 1140, a bolt assembly 1150, a geared motor assembly 1160, an antenna cover 1170, and an front panel back cover 1180. The bolt assembly 1150 and the geared motor assembly 1160 that are provided on the upper portion of the front panel assembly 1100 together with the first snap-fit lock of the rear panel at the corresponding position generally forms the installation mechanism. In this example, the installation mechanism further comprises a snap-fit groove of the middle frame and the second snap-fit lock (FIG. 6) at the bottom of the rear panel.

### Front Panel

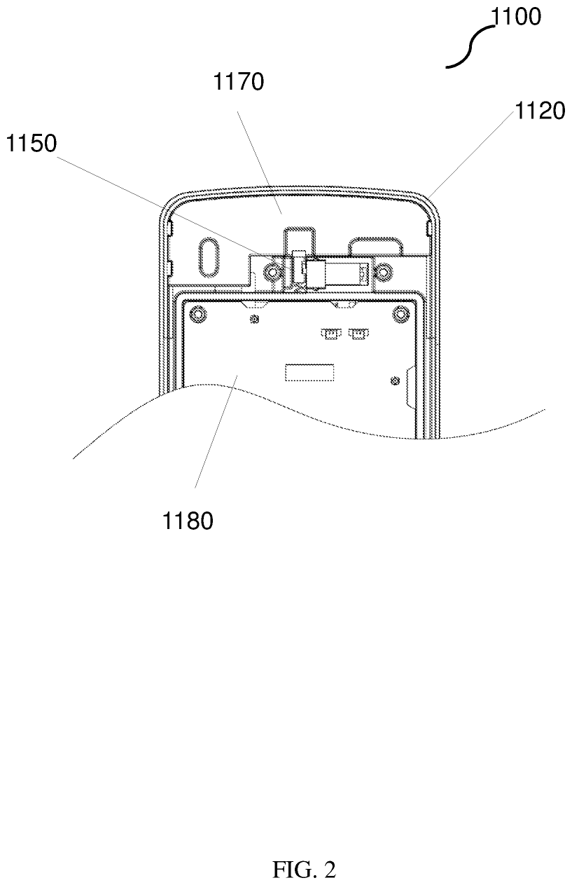

Now referring to FIGS. 1 and 2. The front panel of the access control device 1100 is provided with a touch screen 1110 that is sized and shaped to match with the front side of the middle frame 1120 and is attached to the front side of the middle frame 1120 for inputting a signal such as a password. By way of example, the touch screen 1110 is or contains a touch screen key panel 1111 allowing a user to input a numeral password. The touch PCBA board 1130 is operably connected between the touch screen 1100 and a main control PCBA board 1140, together fitted into the front side of the front panel middle frame 1120. The main control PCBA board 1140 is positioned behind the touch PCBA board 1130 within the front panel middle frame 1120 and is operably connected to the touch PCBA board 1130. When a user enters an input signal (such as a password) via the touch screen 1110, the input signal is received by the main PCBA board 1140 through the touch PCBA board 1130. The main PCBA main board 1140 contains a control system that can determine whether the input signal matches with the predetermined password, and sends a locking signal or unlocking signal to the geared motor assembly 1160. The antenna cover 1170 is positioned on the top, back side of the middle frame 1120, above the touch PCBA board 1130 and the main PCBA board 1140 to provide protection for antenna. The middle frame of front panel 1120 is further installed with the bolt assembly 1150 and the geared motor assembly 1160, both of which are provided at the upper portion of the front panel middle frame 1120, and are operably connected to the main control PCBA board 1140. The front panel back cover 1180 is fastened to the rear side of the front panel middle frame 1120 via screws to form part of the front panel 1100.

### Bolt Assembly

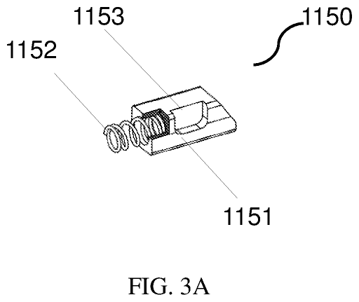

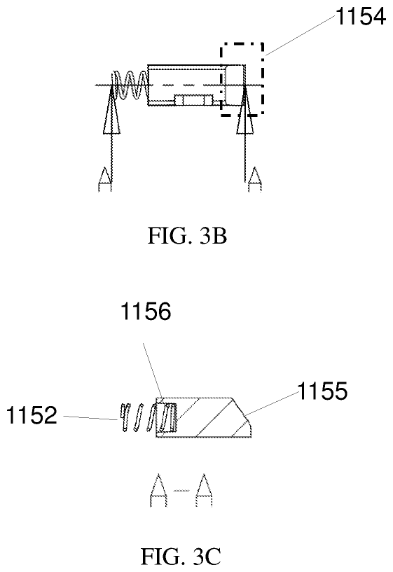

Now referring to FIGS. 2 and 3A-3C. FIG. 3A is a perspective and FIG. 3B is a front view of the bolt assembly 1150. FIG. 3C is a cross-sectional view of cross section A-A in FIG. 3B. The bolt assembly 1150 contains a bolt body 1151 and a bolt spring 1152, and the bolt body 1151 contains a bolt head portion 1154 and a bolt slot 1153. The bolt head portion has a guiding slant side 1155. A bottom end of the bolt assembly 1150 is provided with an accommodating cavity 1156 configured to receive a portion of the bolt spring 1152. The rest portion of the bolt spring 1152 extends beyond the accommodating cavity 1156 and abuts against an inner wall of the front panel middle frame 1120 (FIG. 2). The middle portion of the bolt body 1151 includes a rectangular bolt slot 1153 with round corners configured to receive and interact with an eccentric shaft 1161 of the geared motor 1160 (FIG. 3A).

### Geared Motor Assembly

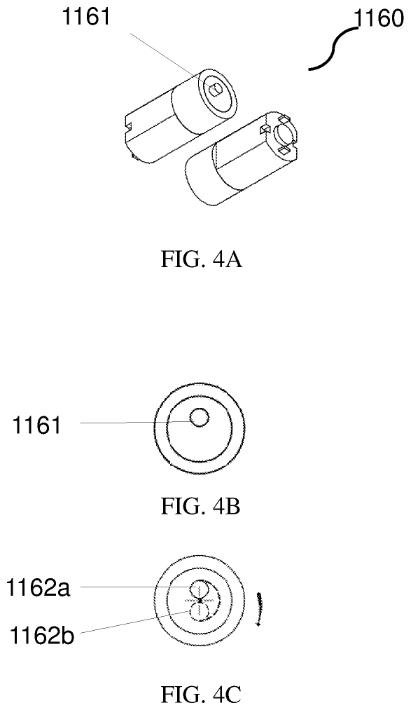

Now referring to FIG. 4A-4B. FIG. 4A-4B show the perspective views and front view of the geared motor assembly which operatively connects with the eccentric shaft 1161 and FIG. 4C shows the upper position 1162a and the lower position 1162b (in dotted lines) of the eccentric shaft 1161 as well as the rotatory motion (also in dotted lines) of the geared motor assembly. The geared motor assembly 1160 is a cylindrical motor that includes the eccentric shaft 1161 on one side of the motor 1160 (FIG. 4A). The eccentric shaft 1161 is in contact with the bolt body 1151 through biasing in the bolt slot 1153 in extended position and retracted position. When the geared motor assembly 1160 is caused to rotate upon receipt of an unlocking signal from the main PCBA board 1140 in response to a correct password inputted from the touch screen 1110, the geared motor assembly 1160 eccentrically rotates about 180 degrees from an upper shaft position 1162a (near the top of the motor) to a lower shaft position 1162b (near the bottom of the motor) as seen in FIG. 4C, which actuates the vertical displacement of the bolt assembly.

### Snap-Fit Mechanisms

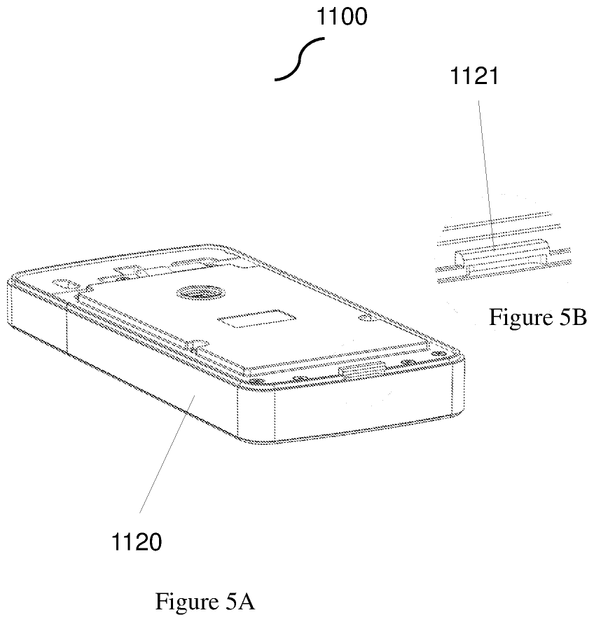

Now referring to FIGS. 5A-5B and FIGS. 6A-6B. FIG. 5A is a perspective view of the rear side of the front panel 1100 and FIG. 5B is an enlarged view thereof. A snap-fit groove 1121 is provided at the bottom of the middle frame 1120 of the front panel 1100 for snap-fit installation of the front panel onto the rear panel 1200.

Now referring to FIG. 6A-6B. FIG. 6A is a cross-sectional view of the access control device. The top of the rear panel is provided with a first snap-fit lock 1201 sized and shaped to snap-fit with the bolt head portion 1154 passing along its guiding slant side 1155. In this example, the bottom of the rear panel 1200 is also provided with a second snap-fit lock 1202 that is shaped and sized to snap-fit the snap-fit groove 1121 in the bottom of the front panel middle frame 1120 (FIG. 6B). As such, the front panel 1100 can be assembled and dissembled by the two snap-fit mechanisms.

### Example 2: Example Methods of Assembly and Disassembly of the Example Access Control Device

Now turning to the example assembly and disassembly processes of any access control device as described herein, such as the example access control device as described in Example 1, by referring to FIGS. 6-11.

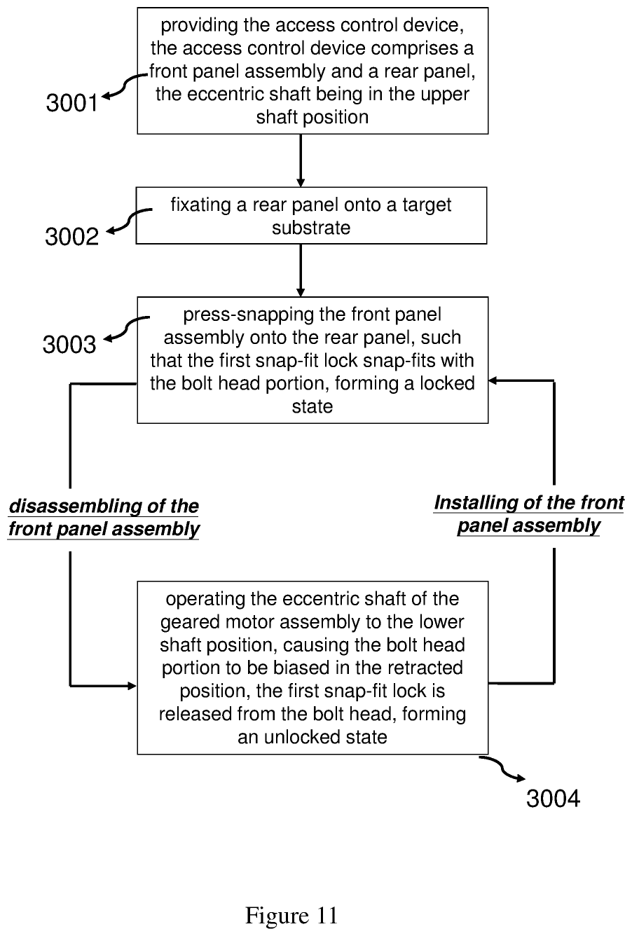

Referring now to FIG. 11, which shows an example method of assembly and disassembly of an access control device with the following steps involved:
(a) Step 3001: providing the access control device, the access control device comprises a front panel assembly and a rear panel, the eccentric shaft being in the upper shaft position;
(b) Step 3002: fixating a rear panel onto a target substrate;
(c) The installing of the front panel assembly includes step 3003: press-snapping the front panel assembly onto the rear panel, such that the first snap-fit lock snap-fits with the bolt head portion, forming a locked state; and
(d) The disassembling the front panel assembly includes step 3004: operating the eccentric shaft of the geared motor assembly to the lower shaft position, causing the bolt head portion to be biased in the retracted position, the first snap-fit lock is released from the bolt head, forming an unlocked state.

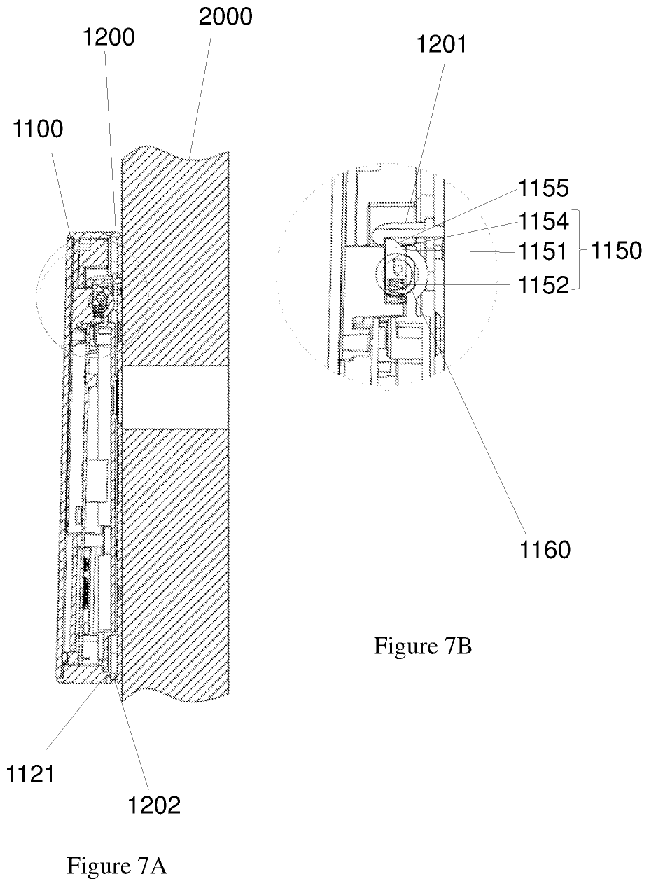

Now referring to FIGS. 6A-6B and FIGS. 7A-7B (with reference to FIGS. 3-4), which show an example embodiment of the process of the installation/assembly of the front panel 1100 to the rear panel 1200 fixated on the door 2000. To install the front panel 1100 onto the rear panel 1200, the snap-fit groove 1121 at the bottom of the rear side of the middle frame 1120 is first obliquely inserted into the second snap-fit lock 1202 of the rear panel 1200. The process is followed by press-snapping the front panel 1100 onto the rear panel 1200 (FIGS. 6A and 6B). The first snap-fit lock 1201 of the rear panel 1200 presses down the guided slant edge 1155 of the bolt body 1151 of the bolt assembly 1150. The bolt body 1151 compresses the bolt spring 1152 and retracts, the first snap-fit lock 1201 passes over the bolt body 1151 and snap-fits with the bolt head portion 1154, forming a locked state (FIGS. 7A and 7B). The assembly is completed.

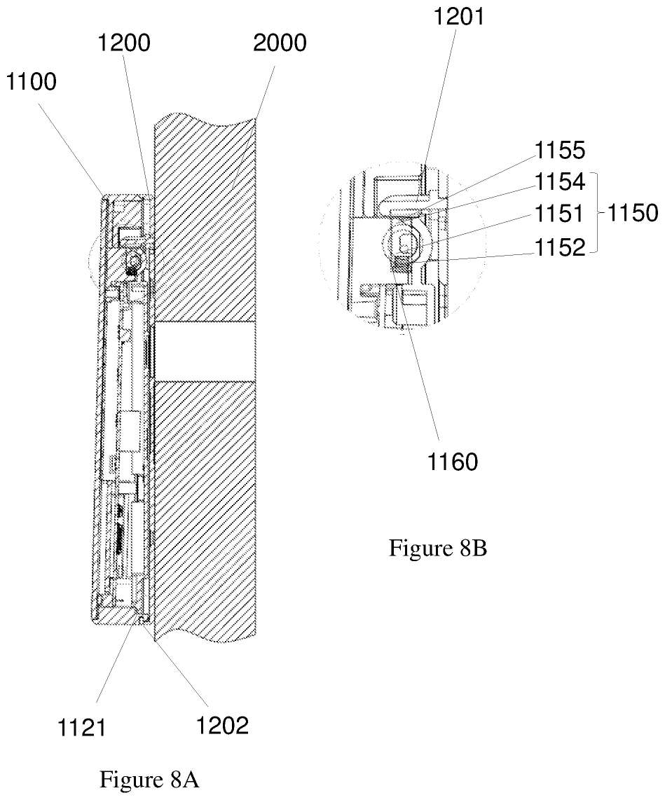

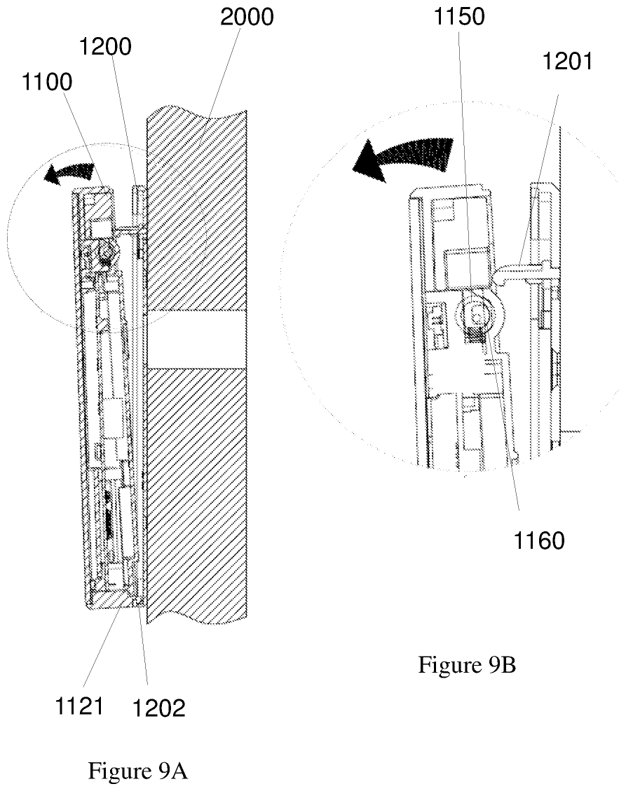

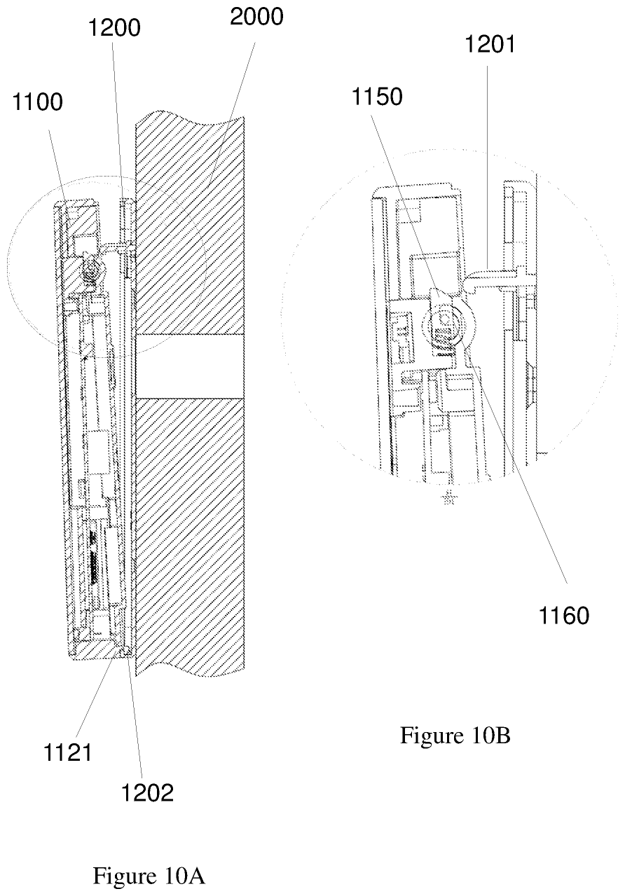

Now referring to FIGS. 8A-8B, FIGS. 9A-9B and FIGS. 10A-10B (with reference to FIGS. 1, 3-4), which show an example embodiment of the process of the disassembly of the front panel 1100 from the rear panel 1200 fixated on a door 2000. To dismantle the front panel 1100 from the rear panel 1200, the user enters a keycode (password) that is verified by the main control PCBA board 1140. Once verified, the main control PCBA board 1140 sends an unlocking signal to cause the geared motor assembly 1160 to eccentrically rotate, operating the eccentric shaft 1161 of the geared motor assembly 1160 from the upper shaft position 1162a to the lower shaft position 1162b (FIGS. 8A and 8B). Since the eccentric shaft 1161 abuts against the bolt slot 1153, such rotation actuates the vertical displacement of the bolt body 1151 of the bolt assembly 1150 with bolt spring 1152, causing the bolt body 1151, including the bolt head portion 1154, to displace downwards from an extended position to a retracted position. In other words, the bolt head portion is biased in the retracted position. The first snap-fit lock 1201 is released from the bolt head portion 1154, forming an unlocked state (FIGS. 9A-9B and FIGS. 10A-10B). The snap-fit groove 1121 of the front panel middle frame 1120 can then be removed from the second snap-fit lock 1202 of the rear panel 1200 to complete the disassembly.

Optionally, either automatically or under users' instructions, the geared motor assembly 1160 rotates back from lower shaft position 1162b to the upper shaft position 1162a through the control of the main control PCBA board 1140, and the bolt spring 1152 pushes the bolt body 1151 upward to reset the state. The bolt head portion 1154 returns to the extended position, forming the locked state (FIGS. 11A and 11B). In one implementation, the geared motor assembly 1160 automatically rotates within a predetermined time interval, e.g., about 5 seconds, 6 second, 10 seconds, 1 minute or more. In one further implementation, the geared motor assembly 1160 automatically rotates within 10 seconds. In another implementation, in response to user's input password (such as via the touch screen key panel 1111) or manual operating instructions (such as via an application operatively connects with the main control PCBA board 1140), the geared motor assembly 1160 rotates back from lower shaft position 1162b to the upper shaft position 1162a.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

Specific numerical data values (such as specific quantities, numbers, categories, etc.) or other specific information should be interpreted as illustrative for discussing example embodiments. Such specific information is not provided to limit example embodiment.

For example, in certain embodiments, a middle frame is provided to accommodate various components including a bolt assembly and a geared motor and fit with the touch screen and the front panel back cover to form the front panel, but in other examples, the front panel having other structural arrangements (such as one integral piece), containing other numbers of components (e.g., two, three, four, five, six, seven, eight, nine, ten or more), different sizes (e.g. oversized) and shapes (e.g. oval or square) at various locations may be used.

For example, in certain embodiments, the front panel contains a bolt and optionally a snap-fit groove, and correspondingly the rear cover contains the matching first and second snap-fit locks, but the other appropriate formats of locking mechanisms, other positions, numbers (e.g., two, three, four, five, six, seven, eight, nine, ten or more), sizes and shapes at various locations may be used.

For example, in certain embodiments, the upper position and the lower position of the shaft is controlled by the eccentric rotation of the shaft, but in other examples, other mechanisms that can effect and be switchable between the two positions may be used instead.

What is claimed is:

1. An access control device, comprising:
a front panel, comprising a bolt assembly and a geared motor assembly;
wherein the bolt assembly comprises a bolt body and a bolt spring;
wherein the bolt body comprises a bolt head portion and a bolt slot; and
a rear panel, comprising a first snap-fit lock;
wherein the first snap-fit lock is sized and shaped to snap-fit with the bolt head portion, and
wherein the geared motor assembly comprises an eccentric shaft, the geared motor assembly is configured to operatively rotate eccentrically, such that the eccentric shaft is switchable between an upper shaft position and a lower shaft position; and
wherein the bolt assembly and the geared motor assembly are constructed and arranged such that the eccentric shaft abuts against the bolt slot, such that
when the eccentric shaft is in the upper shaft position, the bolt head portion is biased in an extended position, the first snap-fit lock is able to snap fit with the bolt head portion, forming a locked state; and
when the eccentric shaft is in the lower shaft position, the bolt head portion is biased in a retracted position, the first snap-fit lock is released from the bolt head portion, forming an unlocked state,
thereby enabling the front panel to be assembled to and disassembled from the rear panel.

2. The access control device of claim 1, wherein the front panel further comprises a front panel middle frame and a main control assembly that is operably connected with the geared motor assembly, the bolt assembly, wherein the geared motor assembly, and the main control assembly are installed into the front panel middle frame.

3. The access control device of claim 2, wherein the front panel middle frame is provided with a snap-fit groove, and the rear panel is provided with a second snap-fit lock that is sized and shaped to match with the snap-fit groove of the front panel middle frame.

4. The access control device of claim 3, wherein the front panel assembly further comprises a touch screen, a touch PCBA board that is operably connected with the touch screen and the main control assembly, such that in response to an input signal from the touch screen, the eccentric shaft is switchable between the upper shaft position and the lower shaft position by controlling the geared motor assembly via the main control assembly, causing the bolt assembly is biased between the extended position and the retracted position.

5. The access control device of claim 1, wherein the bolt body comprises an accommodating cavity to receive at least a portion of the bolt spring, the opposing portion of the bolt spring abuts against an inner wall of the front panel middle frame.

6. The access control device of claim 1, wherein the front panel further comprises a front panel back cover, comprising a back cover front face and a back cover rear face, the back cover front face is sized and shaped to fixedly connect with the front panel middle frame, and the back cover rear face is sized and shaped to match with the rear panel.

7. The access control device of claim 1, wherein a top portion of the front panel further comprises an antenna cover.

8. The access control device of claim 1, wherein the rear panel comprises a rear panel front face and an opposing, rear panel back face, the rear panel back face is configured to be fixable onto a target substrate, and the rear panel front face comprises the first snap-fit lock.

9. The access control device of claim 1, wherein the bolt head portion further comprises a guiding slant side.

10. An installation mechanism for assembling and disassembling an access control device that comprises a front panel and a rear panel, the installation mechanism comprising:
a bolt assembly and a geared motor assembly that are provided on the front panel assembly;
wherein the bolt assembly comprises a bolt body and a bolt spring;
wherein the bolt body comprises a bolt head portion and a bolt slot; and
a first snap-fit lock that is provided on the rear panel,
wherein the first snap-fit lock is sized and shaped to snap fit with the bolt head portion,
wherein the geared motor assembly comprises an eccentric shaft, the geared motor is configured to rotate eccentrically, such that the eccentric shaft is switchable between an upper shaft position and a lower shaft position, and
wherein the bolt assembly and the geared motor assembly are constructed and arranged such that the eccentric shaft abuts against the bolt slot, such that
when the eccentric shaft is in the upper shaft position, the bolt head portion is biased in an extended position, the first snap-fit lock can snap-fit with the bolt head portion, forming a locked state; and
when the eccentric shaft is in the lower shaft position, the bolt head portion is biased in a retracted position, the first snap-fit lock is released from the bolt head portion, forming an unlocked state,
thereby enabling the front panel to be assembled to and disassembled from the rear panel.

11. The mechanism of claim 10, wherein the front panel further comprises a front panel middle frame and a main control assembly, the geared motor assembly is operably connected with the main control assembly, wherein the bolt assembly, the geared motor assembly and the main control assembly are installed into the front panel middle frame.

12. The mechanism of claim 11, further comprising a snap-fit groove that is provided on the front panel middle frame, and a second snap-fit lock that is provided on corresponding bottom portion of the rear panel and that is sized and shaped to match with the snap-fit groove.

13. The mechanism of claim 10, wherein the front panel assembly further comprises a touch screen, a touch PCBA board that is operably connected with the touch screen and the main control assembly, such that in response to an input signal from the touch screen, the eccentric shaft is switchable between the upper shaft position and the lower shaft position by controlling the geared motor assembly via the main control assembly, causing the bolt assembly is biased between the extended position and the retracted position.

14. The mechanism of claim 10, wherein the bolt body comprises an accommodating cavity to receive at least a portion of the bolt spring, the opposing portion of the bolt spring abuts against an inner wall of the front panel middle frame.

15. The mechanism of claim 10, wherein the rear panel comprises a rear panel front face and an opposing, rear panel back face, the rear panel back face is configured to be fixable onto a target substrate, and the first snap-fit lock is disposed on the rear panel front face.

16. The mechanism of claim 10, wherein the bolt head portion further comprises a guiding slant side.

17. A method of assembling and disassembling an access control device, comprising the steps of:
providing the access control device of any one of claims 1-9, the access control device comprises a front panel assembly and a rear panel, the eccentric shaft being in the upper shaft position;
fixating a rear panel onto a target substrate;
wherein installing of the front panel assembly comprises the steps of:
press-snapping the front panel assembly onto the rear panel, such that the first snap-fit lock snap-fits with the bolt head portion, forming a locked state; and
wherein disassembling of the front panel assembly comprises the steps of:
operating the eccentric shaft of the geared motor assembly to the lower shaft position, causing the bolt head portion to be biased in the retracted position, the first snap-fit lock is released from the bolt head, forming an unlocked state, thereby the front panel assembly being disassembled from the rear panel.

18. The method of claim 17, wherein the front panel assembly further comprises a touch screen and a touch PCBA board, the touch PCBA board is operably connected with the touch screen and the main control assembly,
wherein the operating the eccentric shaft of the geared motor assembly is performed by controlling the geared motor assembly via the main control assembly in response to an input signal from the touch screen, the eccentric shaft is switchable between the upper shaft position and the lower shaft position, causing the bolt assembly is biased between the extended position and the retracted position.

19. The method of claim 17, prior to the press-snapping the front panel assembly onto the rear panel, further comprising the step of:
inserting the snap-fit groove of the front panel assembly into the second snap-fit lock that is provided on corresponding bottom portion of the rear panel and that is sized and shaped to match with the snap-fit groove.

20. The method of claim 17, after disassembling the front panel assembly, further comprising the step of:
rotating the geared motor to switch the eccentric shaft back to the upper shaft position, such that the bolt head portion is biased in the extended position, returning to the initial, locked state.
